(19) United States
(12) Patent Application Publication
(10) Pub. No.: US 2010/0142089 A1
(43) Pub. Date: Jun. 10, 2010

(54) PERPENDICULAR MAGNETIC STORAGE MEDIUM AND STORAGE APPARATUS

(75) Inventor: Masaya SUZUKI, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Tokyo (JP)

(21) Appl. No.: 12/603,175

(22) Filed: Oct. 21, 2009

(30) Foreign Application Priority Data
Oct. 23, 2008 (JP) 2008-272720

(51) Int. Cl. G11B 5/127; G11B 5/82

(52) U.S. Cl. 360/110; 360/135; G9B/5.04; G9B/5.293

(57) ABSTRACT

An underlayer includes concentric soft magnetic bodies extending along the surface of a substrate. The soft magnetic bodies are separated from one another by concentric nonmagnetic bodies and configured to have the axis of easy magnetization set parallel to the surface of the substrate. A magnetic recording film extends along the surface of the underlayer. The magnetic recording film is configured to have the axis of easy magnetization in the perpendicular direction orthogonal to the surface of the substrate. The nonmagnetic bodies are arranged at pitch intervals each equal to or smaller than half a predetermined track pitch. The nonmagnetic bodies serve to restrict the flow of magnetic field in the radial direction in the underlayer. The magnetic field is prevented from acting on the adjacent recording tracks. The inversion of magnetization is reduced in the adjacent recording tracks. Side track erasure is suppressed.

### CROSS-REFERENCE TO RELATED APPLICATION

This application is based upon and claims the benefit of priority from the prior Japanese Patent Application No. 2008-272720 filed on Oct. 23, 2008, the entire contents of which are incorporated herein by reference.

### FIELD

The embodiment discussed herein is related to a storage apparatus such as a hard disk drive, HDD. In particular, the embodiment is related to a perpendicular magnetic storage medium incorporated in the storage apparatus.

### BACKGROUND

So-called perpendicular magnetic recording is well known. A perpendicular magnetic storage medium is utilized for perpendicular magnetic recording. The perpendicular magnetic storage medium includes a soft magnetic underlayer supported on a substrate. The soft magnetic underlayer extends on the surface of the substrate. The axis of easy magnetization is set in the soft magnetic underlayer in parallel with the surface of the substrate. A magnetic recording film extends on the surface of the underlayer. The axis of easy magnetization is set in the magnetic recording film in the perpendicular direction orthogonal to the surface of the substrate.

Publication 1: JP Patent Application Publication No. 1-217724

Publication 2: JP Patent Application Publication No. 5-159270

A magnetic field is applied to the magnetic recording film from a write element in the perpendicular direction for magnetic recording. The magnetic field is directed to the soft magnetic underlayer. The magnetic field flows back into the write element from the soft magnetic underlayer. The magnetic field causes inversion of magnetization recorded in the adjacent recording track. Such a phenomenon is called side track erasure. An expected increase in the recording density requires suppression of this side track erasure.

### SUMMARY

It is accordingly an object in one aspect of the embodiment to provide a perpendicular magnetic storage medium significantly contributing to suppression of side track erasure.

According to an aspect of the invention, a perpendicular magnetic storage medium includes: a substrate; an underlayer supported on the substrate, the underlayer extending along the surface of the substrate, the underlayer including concentric soft magnetic bodies separated from one another by concentric nonmagnetic bodies, the concentric soft magnetic bodies each having the axis of easy magnetization set parallel to the surface of the substrate; and a magnetic recording film extending along the surface of the underlayer, the magnetic recording film having the axis of easy magnetization set in the perpendicular direction orthogonal to the surface of the substrate. In this case, the nonmagnetic bodies are arranged at pitch intervals each equal to or smaller than half a predetermined track pitch.

The nonmagnetic bodies serve to restrict the flow of a magnetic field in the radial direction in the underlayer. The magnetic field is thus prevented from acting on the adjacent recording tracks. The inversion of magnetization is reduced in the adjacent recording tracks. Side track erasure is accordingly suppressed.

The object and advantages of the embodiment will be realized and attained by means of the elements and combinations particularly pointed out in the appended claims. It is to be understood that both the foregoing general description and the following detailed description are exemplary and explanatory and are not restrictive of the embodiment, as claimed.

### BRIEF DESCRIPTION OF THE DRAWINGS

FIG. 1 is a plan view schematically illustrating a hard disk drive, HDD, as a specific example of a storage apparatus;

FIG. 2 is an enlarged perspective view schematically illustrating a flying head slider;

FIG. 3 is an enlarged plan view schematically illustrating an electromagnetic transducer observed at a bottom surface;

FIG. 4 is a sectional view taken along the line 4-4 in FIG. 3;

FIG. 5 is an enlarged sectional view taken within a plane including the central axis of a disk;

FIG. 6 is a schematic view illustrating the relationship between a track pitch and pitch intervals between soft magnetic circles;

FIG. 7 is a schematic view illustrating the relationship between read-out tracks and the pitch intervals between the soft magnetic circles;

FIG. 8 is an enlarged sectional view, corresponding to FIG. 5, schematically illustrating a soft magnetic film and a thermoplastic resin film overlaid on the surface of a substrate;

FIG. 9 is an enlarged sectional view, corresponding to FIG. 5, schematically illustrating the process of ion milling;

FIG. 10 is an enlarged sectional view, corresponding to FIG. 5, schematically illustrating the soft magnetic circles formed on the substrate;

FIG. 11 is an enlarged sectional view, corresponding to FIG. 5, schematically illustrating the process of sputtering; and

FIG. 12 is an enlarged sectional view, corresponding to FIG. 5, schematically illustrating an underlayer after polishing and flattening process.

### DESCRIPTION OF EMBODIMENT

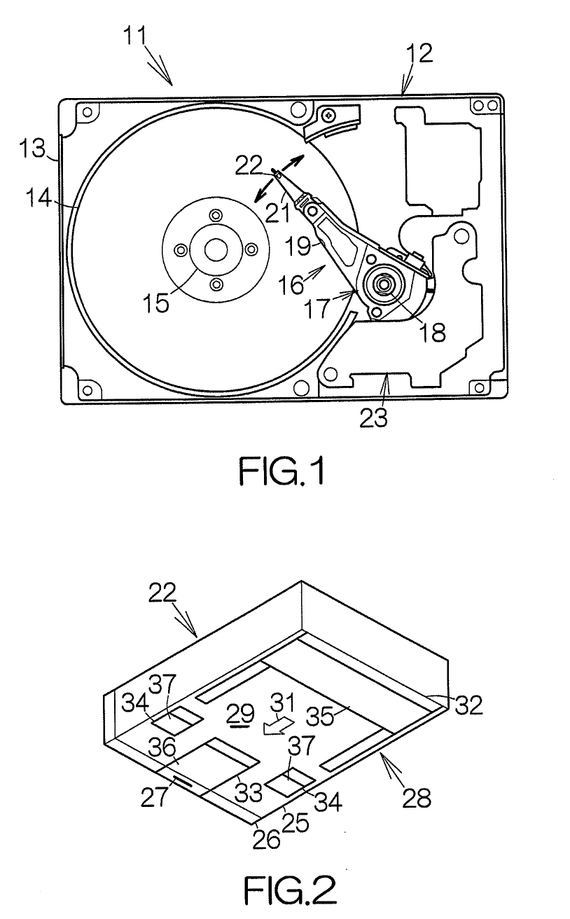

FIG. 1 schematically illustrates the structure of a hard disk drive, HDD, 11 as an example of a storage medium drive or storage apparatus. The hard disk drive 11 includes an enclosure 12. The enclosure 12 includes a box-shaped enclosure base 13 and an enclosure cover, not illustrated. The box-shaped enclosure base 13 is configured to define an inner space in the shape of a flat parallelepiped, for example. The box-shaped enclosure base 13 may be made of a metallic material such as aluminum (Al), for example. Casting process may be employed to form the box-shaped enclosure base 13. The enclosure cover is coupled to the box-shaped enclosure base 13. The enclosure cover closes the opening of the box-shaped enclosure base 13 so as to establish a closed inner space. Pressing process may be employed to form the enclosure cover out of a plate material, for example.

At least one magnetic recording disk 14 as a storage medium is placed in the inner space of the box-shaped enclosure base 13. The magnetic recording disk or disks 14 are mounted on the driving shaft of a spindle motor 15. The spindle motor 15 drives the magnetic recording disk or disks 14 for rotation at a higher revolution speed such as 5,400 rpm, 7,200 rpm, 10,000 rpm, 15,000 rmp, or the like. Here, the magnetic recording disk 14 is configured as a so-called vertical magnetic recording medium or disk, for example. The magnetic recording disk 14 will be described later in detail.

A carriage 16 is also placed in the inner space of the box-shaped enclosure base 13. The carriage 16 includes a carriage block 17. The carriage block 17 is coupled to a vertical pivotal shaft 18 for relative rotation. Carriage arms 19 are defined in the carriage block 17. The carriage arms 19 extend in the horizontal direction from the vertical pivotal shaft 18. The carriage block 17 may be made of aluminum (Al), for example. Extrusion process may be employed to form the carriage block 17, for example.

A head suspension 21 is attached to the front or tip end of the individual carriage arm 19. The head suspension 21 extends forward from the carriage arm 19. A flexure is attached to the head suspension 21. The flexure defines a so-called gimbal at the front or tip end of the head suspension 21. A magnetic head slider, namely a flying head slider 22, is supported on the gimbal. The gimbal allows the flying head slider 22 to change its attitude relative to the head suspension 21. A magnetic head, namely an electromagnetic transducer, is mounted on the flying head slider 22. The electromagnetic transducer will be described later in detail.

When the magnetic recording disk 14 rotates, the flying head slider 22 is allowed to receive airflow generated along the rotating magnetic recording disk 14. The airflow serves to generate a positive pressure or lift as well as a negative pressure on the flying head slider 22. The lift of the flying head slider 22 is balanced with the urging force of the head suspension 21 and the negative pressure so that the flying head slider 22 keeps flying above the surface of the magnetic recording disk 14 at a higher stability during the rotation of the magnetic recording disk 14.

A power source such as a voice coil motor, VCM, 23 is coupled to the carriage block 17. The voice coil motor 23 serves to drive the carriage block 17 around the vertical pivotal shaft 18. The rotation of the carriage block 17 allows the carriage arms 19 and the head suspensions 21 to swing. When the individual carriage arm 19 swings around the vertical pivotal shaft 18 during the flight of the flying head slider 22, the flying head slider 22 is allowed to move in the radial direction of the magnetic recording disk 14. The electromagnetic transducer on the flying head slider 22 is thus allowed to cross the data zone defined between the innermost and outermost recording tracks. The electromagnetic transducer on the flying head slider 22 is positioned right above a target recording track on the magnetic recording disk 14.

FIG. 2 illustrates a specific example of the flying head slider 22. The flying head slider 22 includes a base material or slider body 25 in the form of a flat parallelepiped, for example. An insulating nonmagnetic film, namely a head protection film 26, is overlaid on the outflow or trailing end surface of the slider body 25. An electromagnetic transducer 27 is embedded in the head protection film 26.

The slider body 25 may be made of a hard nonmagnetic material such as Al₂O₃—TiC. The head protection film 26 is made of a relatively soft material having insulating and nonmagnetic properties, such as Al₂O₃ (alumina). A bottom surface 28 as a medium-opposed surface is defined over the slider body 25 to face the magnetic recording disk 14 at a distance. A flat base surface 29 as a reference surface is defined in the bottom surface 28. When the magnetic recording disk 14 rotates, airflow 31 flows along the bottom surface 28 from the inflow or leading end toward the outflow or trailing end of the slider body 25.

A front rail 32 is formed on the bottom surface 28 of the slider body 25. The front rail 32 stands upright from the base surface 29 near the inflow end of the slider body 25. The front rail 32 extends along the inflow end of the base surface 29 in the lateral direction of the slider body 25. A rear center rail 33 is likewise formed on the bottom surface 28 of the slider body 25. The rear center rail 33 stands upright from the base surface 29 near the outflow end of the slider body 25. The rear center rail 33 is placed at the intermediate position in the lateral direction of the slider body 25. The rear center rail 33 extends to reach the head protection film 26. A pair of rear side rails 34, 34 is likewise formed on the bottom surface 28 of the slider body 25. The rear side rails 34, 34 stand upright from the base surface 29 of the bottom surface 28 near the outflow end of the slider body 25. The rear side rails 34, 34 are placed along the sides of the slider body 25, respectively. The rear center rail 33 is placed in a space between the rear side rails 34, 34.

Air bearing surfaces 35, 36, 37, 37 are defined on the top surfaces of the front rail 32, the rear center rail 33 and the rear side rails 34, respectively. Steps are formed to connect the inflow ends of the air bearing surfaces 35, 36, 37, 37 to the top surfaces of the front rail 32, the rear center rail 33 and the rear side rails 34, respectively. When the bottom surface 28 of the flying head slider 22 receives the airflow 31, the steps serve to generate a larger positive pressure or lift at the air bearing surfaces 35, 36, 37, 37, respectively. Moreover, a larger negative pressure is generated behind the front rail 32 or at a position downstream of the front rail 32. The negative pressure is balanced with the lift so as to stably establish the flying attitude of the flying head slider 22. It should be noted that the flying head slider 22 can take any shape or form different from the described one.

The electromagnetic transducer 27 is embedded in the rear center rail 33 at a position downstream of the air bearing surface 36. The electromagnetic transducer 27 includes a read element and a write element, for example. A tunnel-junction magnetoresistive (TuMR) element is employed as the read element. The TuMR element is allowed to induce variation in the electric resistance of the tunnel-junction film in response to the inversion of polarization in the applied magnetic field leaked from the magnetic recording disk 14. This variation in the electric resistance is utilized to discriminate binary data recorded on the magnetic recording disk 14. A so-called single-pole head is employed as the write element. The single-pole head generates a magnetic field with the assistance of a thin film coil pattern. The generated magnetic field is utilized to record binary data into the magnetic recording disk 14. The electromagnetic transducer 27 allows the read gap of the read element and the write gap of the write element to get exposed at the surface of the head protection film 26. A hard protection film is formed on the surface of the head protection film 26 at a position downstream of the air bearing surface 36. Such a protection film covers over the write gap and the read gap exposed at the surface of the head protection film 26. The protection film may be made of a diamond like carbon (DLC) film, for example.

As illustrated in FIG. 3, the read element 38 includes a tunnel-junction magnetoresistive (TuMR) film 42 interposed between a pair of electrically-conductive layers, namely a lower electrode 39 and an upper electrode 41. The lower electrode 39 and the upper electrode 41 may be made of a material having a high magnetic permeability such as FeN (iron nitride), NiFe (nickel iron), NiFeB (nickel iron boron) or CoFeB (cobalt iron boron). The thicknesses of the lower electrode 39 and the upper electrode 41 are set in a range from 2.0 μm to 3.0 μm, for example. The lower electrode 39 and the upper electrode 41 serve as a lower shielding layer and an upper shielding layer, respectively. Space between the lower and upper electrodes 39, 41 serves to determine a linear resolution of magnetic recordation on the magnetic recording disk 14 along the recording track.

A tunnel-junction magnetoresistive film 42 includes a fixed magnetization layer and a free magnetization layer. The fixed magnetization layer and the free magnetization layer extend on the lower electrode 39 in parallel with the surface of the lower electrode 39. An insulating layer, namely a tunnel barrier layer, is sandwiched between the fixed magnetization layer and the free magnetization layer. The fixed magnetization layer, the free magnetization layer and the tunnel barrier layer are formed as a multilayered body on the surface of the lower electrode 39. A sensing current is supplied in the direction perpendicular to the surface of the lower electrode 39.

The fixed magnetization layer includes a pinning layer and a pinned layer, for example. The pinning layer is an antiferromagnetic layer. The pinned layer is a ferromagnetic layer. The pinning layer is made of IrMn (iridium manganese), for example. The pinned layer is made of CoFe (cobalt iron), for example. Exchange coupling is established between the pinned layer and the pinning layer. The exchange coupling serves to fix the magnetization of the pinned layer in a predetermined direction even in the presence of an external magnetic field. The free magnetization layer is a multilayered body including a NiFe (nickel iron) layer, a Ta (tantalum) layer and a CoFeB (cobalt iron boron) layer. The free magnetization layer enables a change in the direction of the magnetization in response to the direction of an external magnetic field. A relative angle changes between the direction of magnetization of the fixed magnetization layer and that of the free magnetization layer. A change in the relative angle induces a variation in the electric resistance of the tunnel-junction magnetoresistive film 42.

A pair of magnetic domain controlling films 43 is placed between the upper electrode 41 and the lower electrode 39. The tunnel-junction magnetoresistive film 42 is interposed between the magnetic domain controlling films 43 along the bottom surface 28. The magnetic domain controlling films 43 are made of a hard magnetic material such as CoCrPt (cobalt chromium platinum), for example. The magnetic domain controlling films 43 are magnetized in a specific single direction along the bottom surface 28. An insulating film 44 is formed between each of the magnetic domain controlling films 43 and the lower electrode 39 as well as between each of the magnetic domain controlling films 43 and the tunnel-junction magnetoresistive film 42. The insulating film 44 is made of Al₂O₃, for example. The thickness of the insulating film 44 may be set in a range from 3.0 nm to 10.0 nm, for example. The insulating film 44 serves to insulate the magnetic domain controlling films 43 from the lower electrode 39 and the tunnel-junction magnetoresistive film 42. Consequently, even if the magnetic domain controlling films 43 have electrical conductivity, a path for a sensing current is limited within the tunnel-junction magnetoresistive film 42 between the upper electrode 41 and the lower electrode 39.

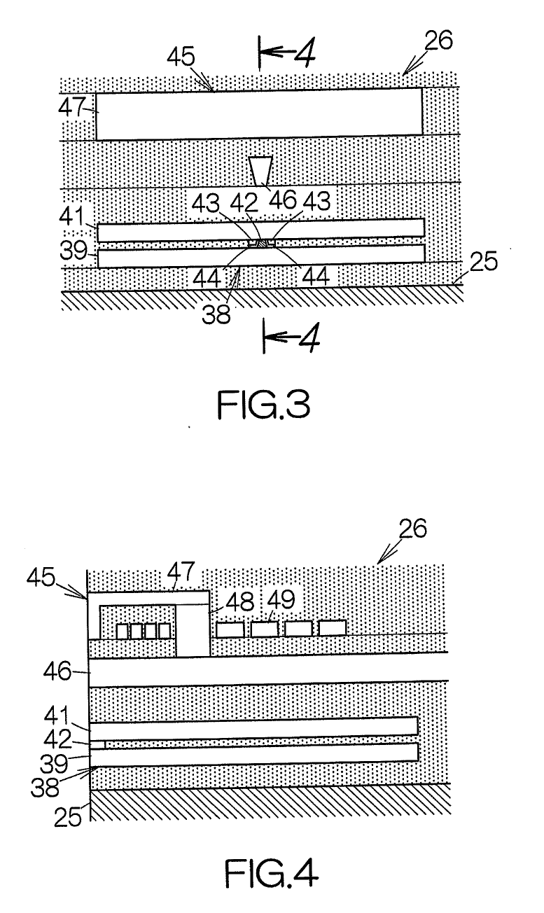

The write element 45, namely the single-pole head, includes a main magnetic pole 46 and an auxiliary magnetic pole 47. The main magnetic pole 46 and the auxiliary magnetic pole 47 are exposed at the surface of the rear center rail 33. The main magnetic pole 46 and the auxiliary magnetic pole 47 may be made of a magnetic material such as FeN, NiFe, NiFeB or CoFeB. Referring also to FIG. 4, a magnetic connecting piece 48 connects the rear end of the auxiliary magnetic pole 47 to the main magnetic pole 46. A magnetic coil, namely a thin film coil pattern 49, is formed in a swirly pattern around the magnetic connecting piece 48. The main magnetic pole 46, the auxiliary magnetic pole 47 and the magnetic connecting piece 48 in combination establish a magnetic core which penetrates through the center of the thin film coil pattern 49.

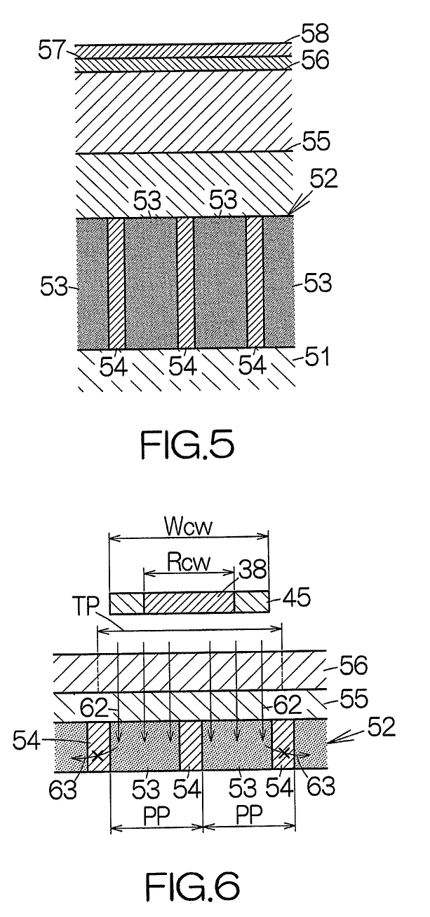

FIG. 5 schematically illustrates the structure of the magnetic recording disk 14. The magnetic recording disk 14 includes a disk-shaped substrate 51. The substrate 51 is made of a nonmagnetic body such as glass, for example. Alternatively, the substrate 51 may be any one of a silicon substrate and an aluminum substrate. The substrate 51 has the flat front and back surfaces.

An underlayer 52 is supported on the substrate 51. The underlayer 52 extends along each of the front and back surfaces of the substrate 51. The underlayer 52 is overlaid on the front surface (back surface) of the substrate 51. The underlayer 52 includes soft magnetic circles 53 in a concentric arrangement. Concentric nonmagnetic annular walls 54 are placed between the adjacent ones of the soft magnetic circles 53 so as to separate the soft magnetic circles 53 from one another. In this manner, the adjacent ones of the soft magnetic circles 53 are magnetically insulated from each other. The soft magnetic circles 53 are made of a soft magnetic material such as FeTaC (iron tantalum carbon) or NiFe (nickel iron), for example. The axis of easy magnetization is set in the individual soft magnetic circle 53 in parallel with the front surface (back surface) of the substrate 51. The nonmagnetic annular walls 54 are made of a nonmagnetic material such as SiO₂, for example. The servo sectors may divide the nonmagnetic annular walls 54 in the circumferential direction, for example. The underlayer 52 has a flat surface.

A nonmagnetic interlayer 55 is supported on the surface of the underlayer 52. The nonmagnetic interlayer 55 extends along the surface of the underlayer 52. The nonmagnetic interlayer 55 is overlaid on the surface of the underlayer 52. The nonmagnetic interlayer 55 may be made of a nonmagnetic alloy containing Co and Cr, for example.

A magnetic recording film 56 is supported on the surface of the nonmagnetic interlayer 55. The magnetic recording film 56 extends along the surface of the nonmagnetic interlayer 55. The magnetic recording film 56 is overlaid on the surface of the nonmagnetic interlayer 55. The magnetic recording film 56 is made of a magnetic material, such as an alloy containing Co and Cr, namely CoCrPt, for example. The axis of easy magnetization is set in the magnetic recording film 56 in the perpendicular direction orthogonal to the surface of the substrate 51. The magnetic recording film 56 includes aggregation of crystal grains. The crystal grains may be magnetically separated from one another based on the segregation of Cr, for example.

A protection film 57 may be supported on the surface of the magnetic recording film 56. The protection film 57 extends along the surface of the magnetic recording film 56. The protection film 57 is overlaid on the surface of the magnetic recording film 56. A hard material such as a diamond like carbon (DLC) may be utilized to form the protection film 57, for example. A lubricating agent film 58 is supported on the surface of the protection film 57. The lubricating agent film 58 extends along the surface of the protection film 57. The lubricating agent film 58 is overlaid on the surface of the protection film 57. A lubricating agent such as perfluoropolyether (PFPE) may be utilized to form the lubricating agent film 58, for example.

Now, assume that magnetic information or binary data is to be written into the magnetic recording disk 14. As illustrated in FIG. 6, the write element 45 is opposed to the surface of the magnetic recording film 56 at a distance. The write element 45 keeps following one of the recording tracks based on the tracking servo control. The read element 38 reads out magnetically recorded information out of servo patterns within the servo sector areas during the tracking servo control. The write element 45 serves to apply a magnetic field 62 to the magnetic recording film 56. The applied magnetic field serves to establish magnetically recorded information.

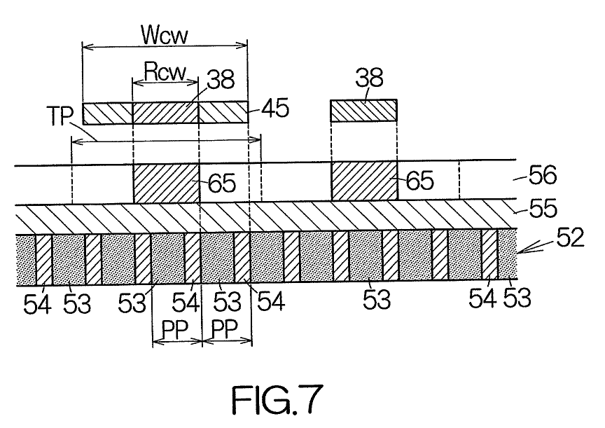

A track pitch TP of a recording track RT is determined based on a core width Wcw of the write element 45. The track pitch TP is equivalent to the track width of a recording track 61. The soft magnetic circles 53 are arranged in the underlayer 52 at a pitch interval PP. The pitch interval PP is set equal to or smaller than half the track pitch TP. The flow of a magnetic field 63 is restricted in the underlayer 52 in the radial direction of the magnetic recording disk 14. This results in suppression of the influence of the magnetic field 63 to the adjacent recording tracks. The inversion of magnetization is reduced in the adjacent recording tracks. So-called side track erasure is suppressed. In this case, the width of the soft magnetic circles 53 is preferably set smaller than the width Wcw of the read element 38. This relationship of the width results in the minimized influence of the inversion during reading operation on the adjacent recording track even if the inversion of magnetization is induced at the edge of the adjacent recording track. In addition, the track pitch TP is set at the minimum track pitch for setting the pitch interval PP between the adjacent ones of the soft magnetic circles 53. This results in a reliable establishment of the pitch interval PP equal to or smaller than half the track pitch TP even when the track pitch TP changes in accordance with the variable track pitch system. As illustrated in FIG. 7, the pitch interval PP may be set equal to or smaller than half the difference between the core width Wcw of the write element 45 and the width Rcw of the read element 38. This relationship results in a reliable establishment of at least one soft magnetic circle 53 between the read-out tracks 65, 65, which are respectively defined in the individual recording tracks when the read element 38 keeps following the recording track 61. Even if the inversion of magnetization is induced at the edge of the adjacent recording track, the influence of the inversion is reliably suppressed during reading operation on the adjacent recording track.

Next, a brief description will be made on a method of making the magnetic recording disk 14. As illustrated in FIG. 8, the substrate 51 is prepared. A soft magnetic film 66 is overlaid on the surface of the substrate 51. The soft magnetic film 66 has a predetermined thickness (50 nm approximately, for example). A thermoplastic resin film 67 is overlaid on the surface of the soft magnetic film 66. A stamper 68 is urged against the thermoplastic resin film 67. In this case, the thermoplastic resin film 67 is subjected to heat to receive the stamper 68. As a result, a notched pattern of the stamper 68 is printed on the thermoplastic resin film 67, as illustrated in FIG. 9. Concentric depressions, namely grooves 69, are formed on the thermoplastic resin film 67. The pattern of the grooves 69 reflects that of the concentric pattern of the nonmagnetic annular walls 54.

The stamper 68 is made of nickel, for example. A silicon substrate, not illustrated, is prepared to form the stamper 68. The surface of the silicon substrate is coated with a resist. The notched pattern is formed on the resist based on the electron beam writing technique. The arrangement of the protrusion of the notched pattern reflects the concentric pattern of the nonmagnetic annular walls 54. The notched pattern is then treated to have the electric conductivity. Electroplating of nickel is subsequently effected on the notched pattern. The stamper 68 is in this manner produced.

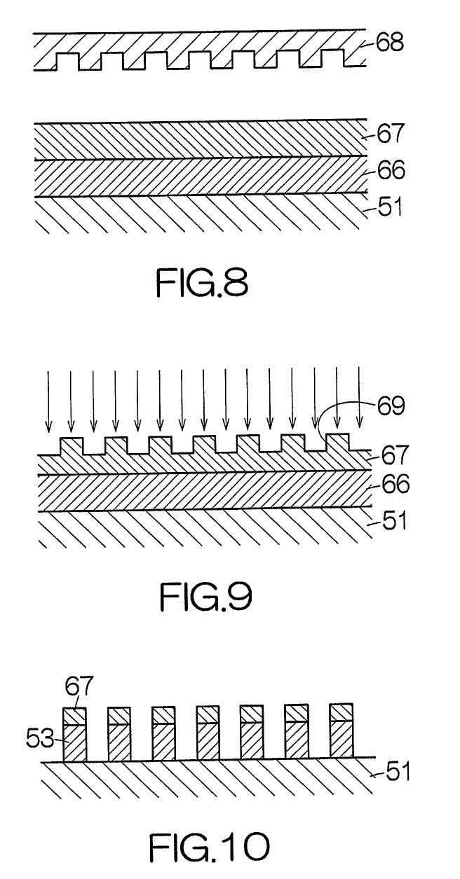

Argon ion milling is effected on the substrate 51. The thermoplastic resin film is utilized as a mask. The soft magnetic film 66 is exposed at the bottoms of the grooves 69. Etching is effected on the soft magnetic film 66 along the grooves 69. In this manner, the soft magnetic circles 53 are shaped out of the soft magnetic film 66, as illustrated in FIG. 10. The thermoplastic resin film 67 remains on the soft magnetic circles 53. Ashing process is applied to the thermoplastic resin film 67. Oxygen plasma is utilized for the ashing process. The thermoplastic resin film 67 is in this manner removed.

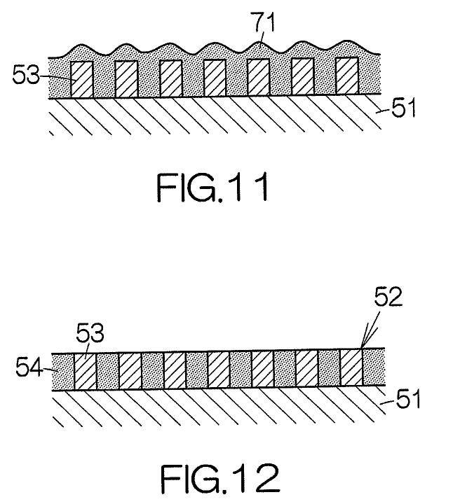

Sputtering is effected on the substrate 51, as illustrated in FIG. 11. A SiO₂ film 71 is formed, for example. The SiO₂ film 71 fills spaces between the soft magnetic circles 53. Polishing and flattening process is then applied to the surface of the substrate 51. Chemical mechanical polishing is employed for the polishing and flattening process, for example. As illustrated in FIG. 12, the surface of the underlayer 52 is flattened. In this manner, the nonmagnetic annular walls 54 are formed between the soft magnetic circles 53. The nonmagnetic interlayer 55, the magnetic recoding film 56 and the protection film 57 are then formed on the surface of the underlayer 52. Sputtering is employed to form the nonmagnetic interlayer 55, the magnetic recoding film 56 and the protection film 57, for example.

What is claimed is:

1. A perpendicular magnetic storage medium comprising:
a substrate;
an underlayer supported on the substrate, the underlayer extending along a surface of the substrate, the underlayer including concentric soft magnetic bodies separated from one another by concentric nonmagnetic bodies, the concentric soft magnetic bodies each having an axis of easy magnetization set parallel to the surface of the substrate; and
a magnetic recording film extending along a surface of the underlayer, the magnetic recording film having an axis of easy magnetization set in a perpendicular direction orthogonal to the surface of the substrate, wherein
the nonmagnetic bodies are arranged at pitch intervals each equal to or smaller than half a predetermined track pitch.

2. The perpendicular magnetic storage medium according to claim 1, wherein the predetermined track pitch is set at a minimum track pitch.

3. The perpendicular magnetic storage medium according to claim 1, wherein the pitch intervals are set equal to or smaller than half a difference between a core width of a write element and a width of a read element.

4. A storage apparatus comprising:
a perpendicular magnetic storage medium;
a write element opposed to the perpendicular magnetic storage medium; and
a read element opposed to the perpendicular magnetic storage medium, wherein
the perpendicular magnetic storage medium includes:
a substrate;
an underlayer supported on the substrate, the underlayer extending along a surface of the substrate, the underlayer including concentric soft magnetic bodies separated from one another by concentric nonmagnetic bodies, the concentric soft magnetic bodies each having an axis of easy magnetization set parallel to the surface of the substrate; and
a magnetic recording film extending along a surface of the underlayer, the magnetic recording film having an axis of easy magnetization set in a perpendicular direction orthogonal to the surface of the substrate, wherein
the nonmagnetic bodies are arranged at pitch intervals each equal to or smaller than half a predetermined track pitch.

5. The storage apparatus according to claim 4, wherein the predetermined track pitch is set at a minimum track pitch.

6. The storage apparatus according to claim 4, wherein the pitch intervals are set equal to or smaller than half a difference between a core width of the write element and a width of the read element.
